(19) United States
(12) Patent Application Publication
(10) Pub. No.: US 2006/0216981 A1
(43) Pub. Date: Sep. 28, 2006

(54) Electric connector

(76) Inventor: Alex Huang, Taipei (TW)

Correspondence Address: Alex Huang, 235 Chung - Ho, Box 8-24, Taipei, TW

(21) Appl. No.: 11/089,410

(22) Filed: Mar. 25, 2005

(51) Int. Cl. H01R 13/15

(52) U.S. Cl. 439/260

(57) ABSTRACT

An electric connector for holding a flexible flat cable or a soft circuit board includes an insulating main body, a signal terminal set, at least a pair of welded reinforcing pieces and a cover. The signal terminal set can be inserted into the insulating main body, with a row of upright hooks and a row of contact members. The welded reinforcing pieces are respectively inserted into two lateral sides of the insulating main body, whereby block parts thereon enclose the furthest two upright hooks. The cover has a row of gaps internally connected through a rotational axle and corresponding to the signal terminal set and the welded reinforcing pieces. As the cover and the insulating main body are connected, the rotational axle is pivotally retained within the upright hooks, so that the cover can rotate around the axle to clip a flexible flat cable or a soft circuit board.

### FIELD OF THE INVENTION

The present invention relates to electric connectors, and more particularly to an electric connector for holding a flexible flat cable or a soft circuit board.

### BACKGROUND OF THE INVENTION

Referring to FIG. 1, an electric connector of the prior art, such as the one disclosed by Japan Patent Number 7-142130, comprises a case la made of an insulating material, a plurality of metallic terminals 2a inserted on the case la and a clipping component 3a pivotally connected to selected locations on the case 1a, whereby the rotation of the component 3a onto the case la will retain a flexible base board 4a within the electric connector.

However, the electric connector of the prior art has several disadvantages as follows.

1. The clipping component 3a is pivotally connected with the case 1a at two ends of the rotational axis, leaving the middle section of the rotational axis suspended and therefore deformable. This effect weakens the clipping of the flexible base board 4a, which may affect the electric contact of the electric connector.

2. As the clipping component 3a is uncovered with respect to the case 1a, it leans against the case 1a at some contact points 11a. Therefore, if the clipping component 3a is rotated too much during upon uncovering, the huge stress concentrated at the contact points 11a may break the clipping component 3a.

3. The reinforced pieces for welding points within the cover la are not tightly attached to the case 1a; it may fall off the case la after repeated folding and unfolding of the clipping components 3a.

4. The pivotal connection of the clipping components 3a to the terminals 2a is done at two ends of the connecting side of the clipping components 3a through C-shaped open connecting units, leading to the possibility that the clipping components 3a may depart from the connecting units due to vibrations.

5. The pivotal connection of the clipping components 3a with the terminals 2a is done by a loose reception of the pivotal portions of the clipping components 3a within the C-shaped connecting portions of the terminals 2a. Therefore, the pivotal portions and the axis of the terminals 2a may not be exactly coaxial.

### SUMMARY OF THE INVENTION

The primary objective of the present invention is to provide an electric connector, wherein the signal terminals, the reinforced piece for welded points, the cover and the insulating main body are simultaneously improved.

The various objects and advantages of the present invention will be more readily understood from the following detailed description when read in conjunction with the appended drawings.

### BRIEF DESCRIPTION OF THE DRAWINGS

FIG. 1 is a cross-sectional view of a local area of an electric connector of the prior art.

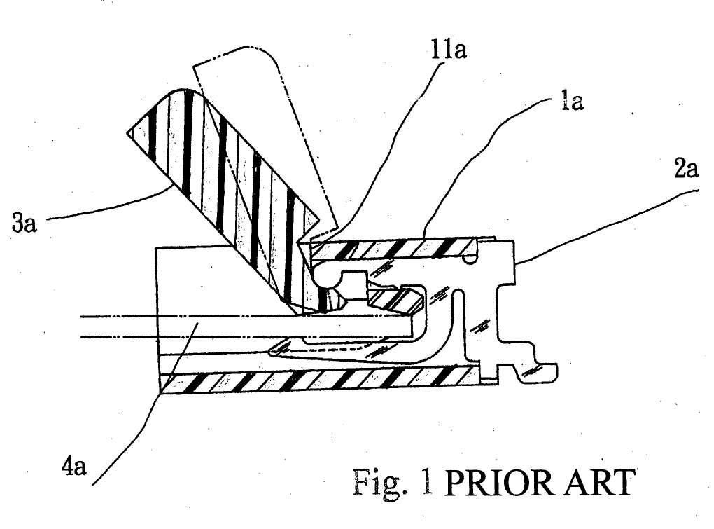

FIG. 2 is an exploded perspective view of an electric connector according to the present invention.

FIG. 3 is a perspective view of the electric connector in FIG. 2, wherein the cover 4 is closed.

FIG. 4 is a lateral view of the electric connector in FIG. 2 wherein the cover 4 is closed.

FIG. 5 is a lateral view of the electric connector in FIG. 2 wherein the cover 4 is flipped open.

FIG. 6 is a front view of the electric connector in FIG. 2 wherein the cover 4 is closed.

FIG. 7 is a cross-sectional view of the electric connector along. line 7-7 of FIG. 2.

FIG. 7a is a cross-sectional view of the electric connector along line 7-7 in FIG. 6. FIG. 8 is a top view of the electric connector in FIG. 2.

FIG. 9 is a cross-sectional view of the electric connector along line 9-9 of FIG. 8.

### DETAILED DESCRIPTION OF THE PREFERRED EMBODIMENT

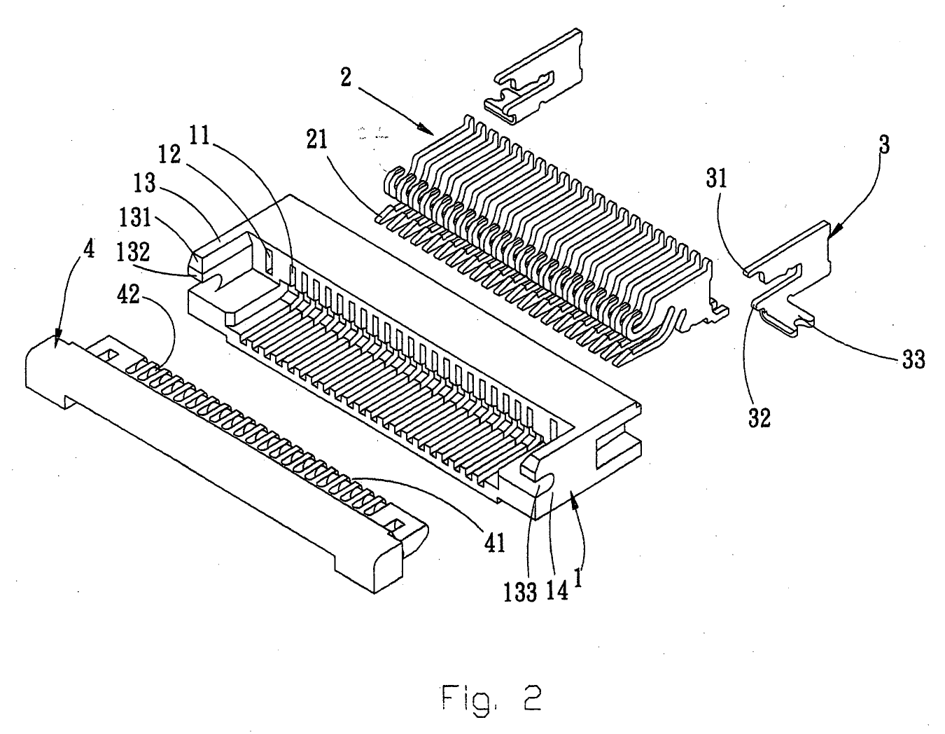

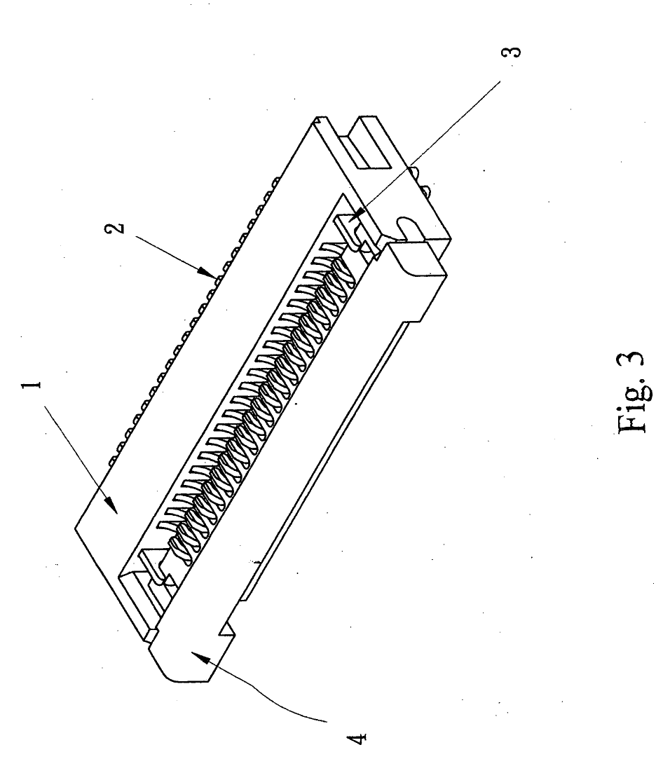

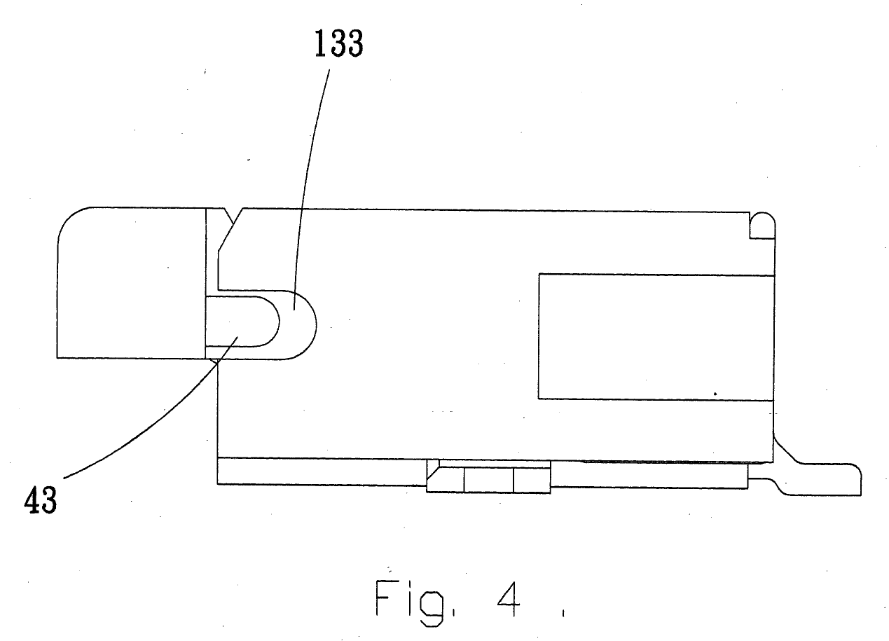

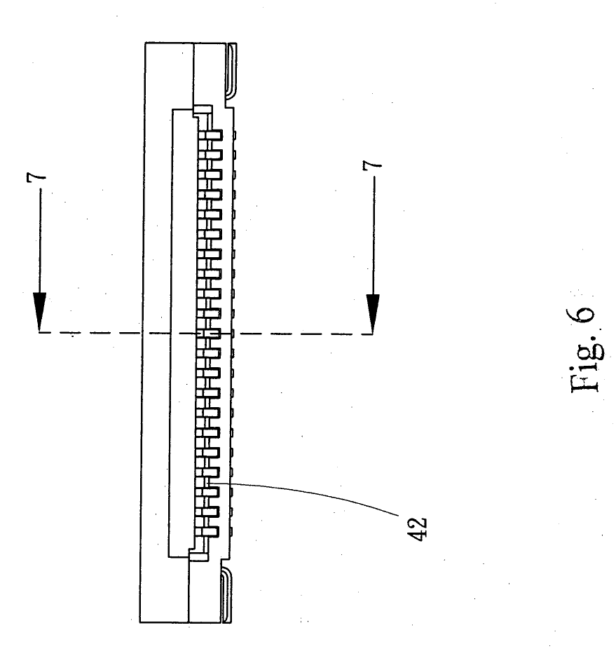

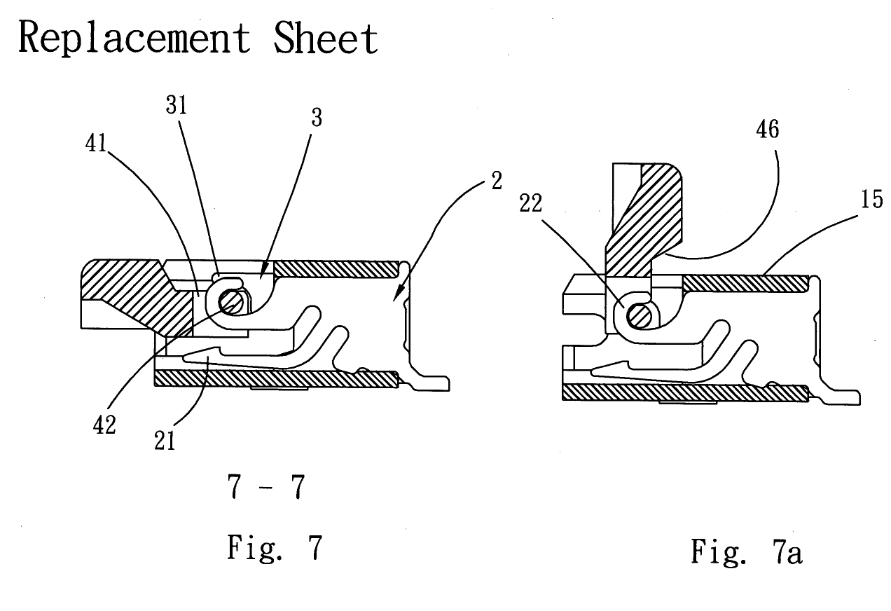

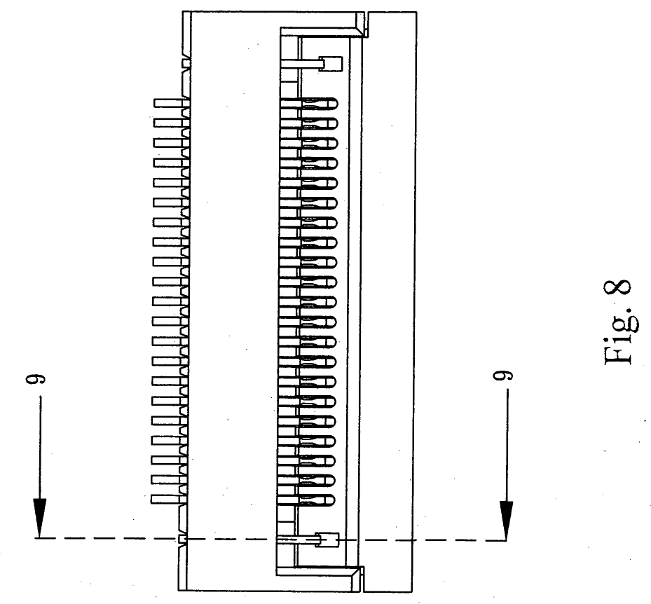

Referring to FIGS. 2 to 9, an electric connector according to the present invention comprises an insulating main body 1, a signal terminal set 2, at least a pair of welded reinforcing pieces 3 and a cover 4.

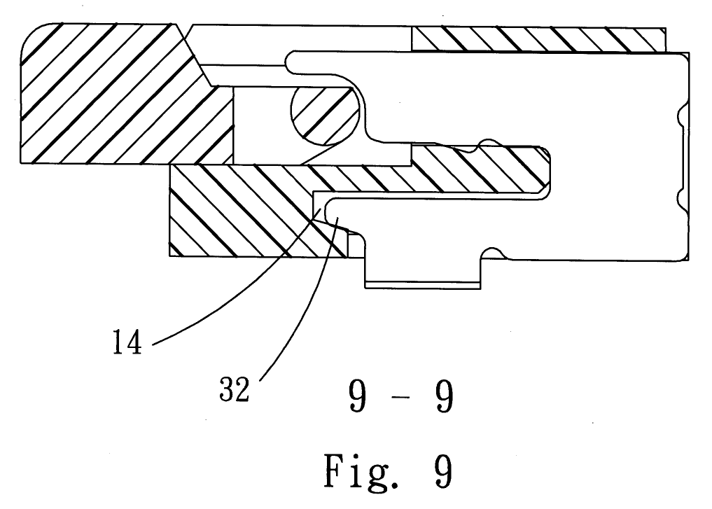

The insulating main body 1 is provided with a plurality of first slots 11 and a plurality of second slots 12. Two sidewalls 13 are formed on either of the lateral sides of the insulating main body 1. The free end of each of the sidewalls 13 is a projected member 131 provided with an inclined face 132. Below each of the sidewalls 13 there is a fillister 133. The insulating main body 1 further includes a top plane 15, and inside the second slots 12 there are a plurality of depressions 14 as shown in FIG. 9.

The signal terminal set 2 is capable of being inserted into the first slots 11 and thereby secured with the insulating main body 1. The signal terminal set 2 further comprises a row of upright hooks 22 and a row of contact members 21 that will be exposed on the insulating main body 1 after the engagement of the signal terminal set 2 with the main body 1.

The upright hooks 22 and the contact members 22 are arranged in an up-down parallel configuration.

The welded reinforcing pieces 3 are secured on the main body 1 by being inserted into the second slots 12. Each of the welded reinforcing pieces 3 further includes a welded part 33, a block part 31 and a protruding part 32. The block part 31 and the protruding part 32 are respectively in up and down opposite positions, and the welded part 33 will extend from a lower lateral side of the main body 1 after the engagement. The welded parts 33 are for the attachment the electric connector to a circuit board (not shown in the figures) by SMT welding.

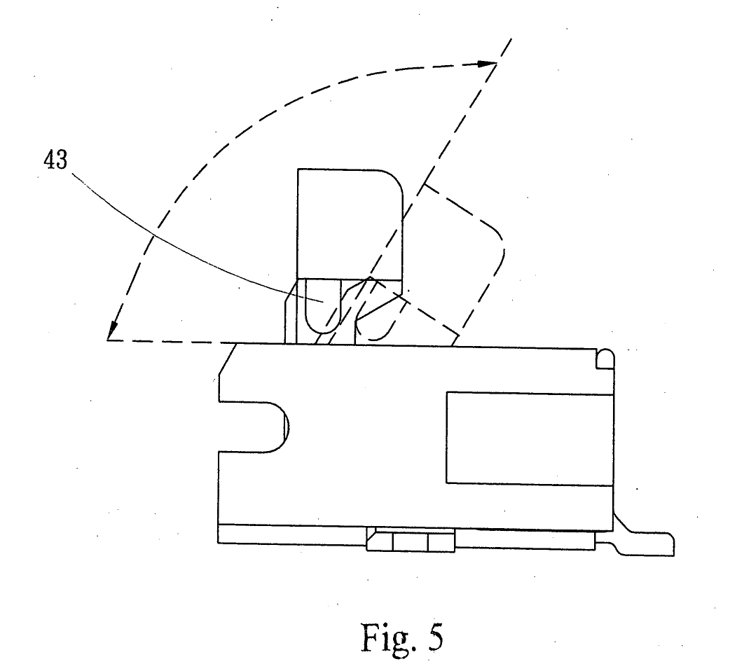

The cover 4 comprises a plurality of gaps 41 capable of being engaged with the signal terminal set 2 and the welded reinforcing pieces 3, when it is combined with the insulating main body 1. The gaps 41 are internally connected with a rotational axle 42. The main section of the rotational axle 42 of the cover 4 is pivotally retained within the upright hooks 22, and two end sections of the rotational axle 42 are retained by the enclosures formed by the upright hooks 22 and the block parts 31. To install the electric connector, the signal terminal set 2 is firstly inserted into the insulating main body 1, and then the cover 4 is engaged with the insulating main body 1, and finally the welded reinforcing pieces 3 are installed, whereby the cover 4 can rotate around the rotational axle 42 to cover the insulating main body 1. The cover 4 further includes a plurality of projections 43 extendable into the fillisters 133 of the insulating main body 1 when it is closed on the insulating main body 1. Each of the projections 43 has a free end that leans against an inclined face 132 of a sidewall 13 before the closure of the cover 4, so that a translational motion of the rotational axle 42 toward the signal terminal set 2 will be activated when the cover 4 is rotated onto the insulating main body 1. Therefore, the rotational axle 42 will be received by the upright hooks 22 when the cover 4 is closed. Moreover, a prop up side plane 46 is formed on one lateral side of the cover 4, whereby as the cover 4 is flipped open over 90 degrees, as shown in FIG. 5, the prop up side plane 46 will push against the top plane 15 of the insulating main body 1, whereby the cover 4 will be protected from breaking up.

Therefore, the cover 4 of the electric connector of the present invention can be opened from or closed on the main body 1 around the rotational axle 42. A flexible flat cable or a soft circuit board can be clipped between the insulating main body 1 and the cover 4, whereby the signal terminal set 2 is brought to an electric contact with them.

The present invention utilizes a combination of the insulating main body 1, the signal terminal set 2, the welded reinforcing pieces 3 and the cover 4 to achieve the advantages as follows.

1. The rotational axle 42 of the cover 4 is connected to the insulating main body 1 not only at its two ends but also within the upright hooks 22 of the signal terminal set 2. Two short end sections of the rotate axle 42 are further retained by two enclosures formed by some of the upright hooks 22 and the block parts 31 of the welded reinforcing pieces 3, so that the rotational axle 42 is not easy to fall off.

2. Since the rotational axle 42 is fully confined along the interface side of the insulating main body 1 and the cover 4, its middle section will not be easily deformed, and therefore the cover 4 can closely cover the insulating main body 1. This will contribute to better engagement of the electric connector with either flexible flat cable or a soft circuit board.

3. The cover 4 further includes a plurality of projections 43 extendable into the fillisters 133 of the insulating main body 1 when it is closed onto the insulating main body 1. Therefore, a translational motion of the rotational axle 42 into the upright hooks 22 of the signal terminal set 2 will be activated when the cover 4 is rotated onto the insulating main body 1.

4. A prop up side plane 46 is formed on one lateral side of the cover 4, whereby as the cover 4 is flipped open over 90 degrees, as shown in FIG. 5, the prop up side plane 46 will push against the top plane 15 of the insulating main body 1, whereby the cover 4 will be protected from breaking up.

5. Each of the welded reinforcing pieces 3 further includes a protruding part 32, and the insulating main body further includes depressions 14 corresponding to the protruding parts 32, whereby the protruding parts 32 and the depressions 14 will be engaged upon the insertion of the welded reinforcing pieces 3 into the insulating main body. Therefore, it is not likely that the welded reinforcing pieces 3 will fall off the insulating main body 1 easily.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1-4. (canceled)

5. An electric connector for holding and electrically connecting an article selected from a flexible flat cable and a soft circuit board, comprising:
an insulating main body being provided with a plurality of first slots and two second slots at two outer sides of the plurality of first slots; two sidewalls being formed on either of two lateral sides of the insulating main body; a free end of each of the sidewalls being a projected member provided with an inclined face; below each of the sidewalls there being a fillister; the insulating main body further including a top plane, and inside each of the second slots there being a depression;
a signal terminal set capable of being inserted into the first slots and thereby secured with the insulating main body; the signal terminal set further comprising a row of upright hooks and a row of contact members that will be exposed on the insulating main body after the engagement of the signal terminal set with the main body 1; the upright hooks and the contact members being arranged in an up-down parallel configuration;
two welded reinforcing pieces being secured on the main body by being inserted into the second slots; each of the welded reinforcing pieces further including a welded part, a block part and a protruding part; the block part and the protruding part being respectively in up and down opposite positions, and the welded part will extend from a lower lateral side of the main body after the engagement; the welded parts serving for attaching the electric connector to a circuit board by SMT welding;
a cover comprising a plurality of gaps capable of being engaged with the signal terminal set and the welded reinforcing pieces, when it is combined with the insulating main body; the gaps being internally connected with a rotational axle; a section of the rotational axle of the cover being pivotally retained within the upright hooks, and two end sections of the rotational axle being retained by the enclosures formed by the upright hooks and the block parts; to install the electric connector, the signal terminal set being firstly inserted into the insulating main body, and then the cover being engaged with the insulating main body, and finally the welded reinforcing pieces being installed, whereby the cover can rotate around the rotational axle to cover the insulating main body.

6. The electric connector as claimed in claim 5, wherein the cover further includes a plurality of projections extendable into the fillisters of the insulating main body when it is closed on the insulating main body; each of the projections has a free end that leans against an inclined face of a sidewall before the closure of the cover, so that a translational motion of the rotational axle toward the signal terminal set will be activated when the cover is rotated onto the insulating main body; therefore, the rotational axle will be received by the upright hooks when the cover is closed.

7. The electric connector as claimed in claim 5, wherein a prop up side plane is formed on one lateral side of the cover, whereby as the cover is flipped open over 90 degrees, the prop up side plane will push against the top plane of the insulating main body, whereby the cover will be protected from breaking up; and thus, the cover of the electric connector is opened from or closed on the main body around the rotational axle; a flexible flat cable or a soft circuit board is clipped between the insulating main body and the cover, whereby the signal terminal set is brought to an electric contact with them.
